(19) United States
(12) Patent Application Publication
(10) Pub. No.: US 2026/0203972 A1
(43) Pub. Date: Jul. 16, 2026

(54) NULL-TEXT INVERSION FOR EDITING REAL IMAGES USING GUIDED DIFFUSION MODELS

(71) Applicant: GOOGLE LLC, Mountain View, CA (US)

(72) Inventors: Kfir Aberman, San Mateo, CA (US); Yael Pritch Knaan, Tel Aviv (IL); Amir Hertz, Tel Aviv (IL); Daniel Cohen-Or, Tel Aviv (IL); Ron Mokady, Tel Aviv (IL)

(21) Appl. No.: 19/130,013

(22) PCT Filed: Nov. 15, 2023
(86) PCT No.: PCT/US2023/079884

§ 371 Date: May 14, 2025

Related U.S. Application Data
(60) Provisional application No. 63/426,007, filed on Nov. 16, 2022.

(51) Int. Cl. G06T 11/60

(52) U.S. Cl. CPC G06T 11/60; G06T 2200/24

(57) ABSTRACT

Implementations are directed to generating an edited synthetic image, that corresponds to a real image captured using a real camera, but that is generated based on, and reflects, edit(s) to an original natural language (NL) caption for the real image. For example, the original NL caption can be used in performing an inversion on the real image to generate a diffusion trajectory for the real image. Further, the diffusion trajectory can be used to optimize a sequence of unconditional embeddings, for the real image, that are not based on the NL caption for the real image. Yet further, the edited NL caption, the unconditional embeddings, and at least part of a noise vector (of the diffusion trajectory) can be processed, using a Large-scale language-image (LLI) model, to generate the edited synthetic image.

### BACKGROUND

Large-scale language-image (LLI) models (e.g., text-guided diffusion models), such as GOOGLE'S IMAGEN, have shown phenomenal generative semantic and compositional power, and have gained unprecedented attention from the research community and the public eye. These LLI models are trained on extremely large language-image datasets and use state-of-the-art image generative models, such as auto-regressive and/or diffusion models. These LLI models enable the generation of images conditioned on plain text, known as text-to-image synthesis. For example, these LLI models enable, in response to a plain text prompt of “photo of dog riding on a bicycle”, generation of a realistic image that reflects a dog riding on a bicycle. Various LLI models have recently emerged that demonstrate unprecedented semantic generation.

Image editing is one of the most fundamental tasks in computer graphics, encompassing the process of modifying an input image through the use of an auxiliary input, such as a label, scribble, mask, or reference image.

However, many LLI models do not provide simple editing means for a generated image, and generally lack control over specific semantic regions of a given image (e.g., using text guidance only). For example, even the slightest change in the textual prompt may lead to a completely different output image being generated using an LLI model. For instance, changing “photo of dog riding on a bicycle” to “photo of white dog riding on a bicycle” can result in a completely different generated image, such as one that changes the dog's shape.

To circumvent this, many proposed LLI-based editing methods require the user to explicitly mask a part of the image to be inpainted, and drive the edited image to change in the masked area only, while matching the background of the original image. However, the masking procedure is cumbersome (e.g., requiring a large quantity of user inputs to define the mask), hampering quick and intuitive text-driven editing. Moreover, masking the image content removes important structural information, which is completely ignored in the inpainting process. Therefore, some editing capabilities are out of the inpainting scope, such as modifying the texture of a specific object.

A specifically intuitive way to edit an image is through textual prompt(s) provided by the user. However, some proposed LLI-based editing methods can lack the ability to edit a generated image through textual prompt(s) at all or lack the ability to edit a generated image through textual prompt(s) exclusively.

Moreover, some proposed LLI-based editing methods may not enable editing of a real image (e.g., captured by a real-world physical camera). For example, some methods may not enable starting with a real image, that includes a basket with apples, and a natural language (NL) caption that is descriptive of the image (e.g., a human provided prompt of “a basket with apples”)—and generating a synthetic version of the real image to include a basket with cookies (in lieu of apples) in response to an edit, to the NL caption, to replace “apples” with “cookies”. For instance, to enable such editing utilizing LLI-based techniques, the real image must be inverted, in view of the corresponding LLI and the NL caption, to enable generating a synthetic version of the real image using the LLI. Put another way, to enable such editing, the real image must be inverted in a manner such that the LLI model can then be utilized to process the inversion, and an edited NL caption, to generate a synthetic image that is visually similar to the real image, but that includes visual modifications consistent with one or more edits that are reflected by the edited NL caption.

### SUMMARY

Implementations of the present disclosure are directed to enabling editing of a real image via editing only an NL caption of the real image (also referred to herein as prompt-to-prompt editing). This enables voice-based, typed (e.g., physical or virtual keyboard), and/or touch-based (e.g., interaction with an emphasis element, selection of alternative term(s)) input to edit a real image, and obviates the need for any specification of an image mask and/or other input(s). Such inputs for editing are natural, can be made with low latency, and enable various editing tasks that are challenging otherwise. Further, implementations disclosed herein do not require extra, and computationally expensive, model training, fine-tuning, extra data, or optimization.

More particularly, some implementations are directed to generating a synthetic image, that corresponds to a real image captured using a real camera, but that is generated based on, and reflects, edit(s) to an original natural language (NL) caption for the real image. In some of those implementations, the original NL caption is used in performing an inversion on the real image to generate a diffusion trajectory for the real image. Further, the diffusion trajectory is used to optimize a sequence of unconditional embeddings, for the real image, that are not based on the NL caption for the real image. Yet further, the edited NL caption, the unconditional embeddings, and at least part of the noise vector can be processed, using a Large-scale language-image (LLI) model, to generate the synthetic image.

As a non-limiting example, assume a user provided or automatically generated NL caption for a real image is “a furry bear watching a bird”, and the real image reflects a furry bear that is watching a bird. The edit(s) to the NL caption can include a replacement of a subset of tokens of the source NL prompt with replacement token(s) (e.g., replacing “bird” with “butterfly”), an addition of token(s) to the source NL prompt (e.g., adding “blue” before “bird”), and/or an adjustment of emphasis on token(s) of the source NL prompt (e.g., increasing emphasis on “fuzzy”). Implementations disclosed herein can utilize such edit(s) to generate a synthetic image, that corresponds to the real image, but that reflects the edit(s). For example, replacing “bird” with “butterfly” can result in generation of a synthetic image that is visually similar to the real image, but that includes the bear watching a butterfly (in lieu of a bird).

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 schematically depicts example components and interactions that can be utilized in implementations disclosed herein.

FIG. 2 illustrates an example method of inverting a real image in view of an NL caption for the real image, including generating and storing, for the real image, a final noise vector and an optimized sequence of unconditional embeddings.

FIG. 3 illustrates an example method of generating, using an LLI model, an edited image that is visually similar to a real image, but that includes visual modifications consistent with an edit to an NL caption for the real image.

FIG. 4 schematically illustrates an example computer architecture on which selected aspects of the present disclosure can be implemented.

### DETAILED DESCRIPTION

Prior to turning to the figures, a non-limiting overview of various implementations is provided.

The progress in image synthesis using LLIs, such as text-guided diffusion models, has attracted much attention due to their exceptional realism and diversity. LLIs have ignited the imagination of multitudes of users, enabling image generation with unprecedented creative freedom. Naturally, this has initiated ongoing research efforts, investigating how to harness these powerful models for image editing. For example, intuitive text-based prompt-to-prompt editing has been recently demonstrated over synthesized images, allowing a user to easily manipulate a synthesized image using text only.

However, text-guided editing of a real image requires inverting the given image and a textual prompt. That is, finding an initial noise vector that produces the input image when fed with the textual prompt into the diffusion process, while preserving the editing capabilities of the model. A deterministic denoising diffusion implicit model (DDIM) inversion scheme has been suggested for unconditional diffusion models (i.e., diffusion models not condition on a textual prompt). However, DDIM can have shortcomings for text-guided diffusion models when classifier-free guidance, which is necessary for meaningful prompt-to-prompt editing, is applied.

In view of these and other considerations, implementations disclosed herein relate to an effective inversion scheme, achieving near-perfect reconstruction, while retaining the rich text-guided editing capabilities of the original model. Those implementations focus on two aspects of guided diffusion models: classifier-free guidance and DDIM inversion. In classifier-free guidance, in each diffusion step, the prediction is performed twice: once unconditionally and once with the text condition. These predictions are then extrapolated to amplify the effect of the text guidance. While the conditional prediction is impactful, implementations disclosed herein also recognize the substantial effect induced by the unconditional part. Accordingly, some of those implementations optimize the embedding used in the unconditional part in order to invert the input image and a text prompt. This is also referred to herein as null-text optimization, as the embedding of the empty text string is replaced with an optimized embedding.

DDIM inversion includes performing DDIM sampling in reverse order. Although a slight error is introduced in each step, this works well in the unconditional case. However, in practice, it breaks for text-guided image synthesis since classifier-free guidance magnifies its accumulated error. Nonetheless, implementations disclosed herein recognize that DDIM inversion offers a promising starting point for the inversion. Those implementations use the sequence of noised latent codes, obtained from an initial DDIM inversion, as a pivot and then perform an optimization around this pivot to yield an improved and more accurate inversion. This is also referred to herein as diffusion pivotal inversion, which stands in contrast to some works that aim to map all possible noise vectors to a single image.

Large-scale diffusion models have recently raised the bar for the task of generating images conditioned on plain text, known as text-to-image synthesis. Exploiting the powerful architecture of diffusion models, these models can generate practically any image by simply feeding a corresponding text to a diffusion model, and have changed the landscape of artistic applications.

However, synthesizing very specific or personal objects which are not widespread in the training data has been challenging. This requires an inversion process that, given an input image, would enable regenerating the depicted object(s) using a text-guided diffusion model. Inversion has been studied for GANs, ranging from latent-based optimization and encoders to feature space encoders and fine-tuning of the model. However, prior works struggle to edit a given real image while accurately reproducing the unedited parts.

Other prior works have attempted to adapt text-guided diffusion models to the fundamental challenge of single-image editing, aiming to exploit their rich and diverse semantic knowledge. However, those prior works struggle to accurately preserve the input image details. To overcome this, those prior works assume that the user provides a mask to restrict the region in which the changes are applied, achieving both meaningful editing and background preservation. However, requiring that users provide a precise mask is burdensome, requiring multiple user inputs. Further, masking the image content removes important information, which is mostly ignored in the inpainting process.

As an overview of some implementations disclosed herein, let I be a real image. Implementations disclosed herein seek to edit I, using only text guidance, to get an edited image I*, where the editing is guided by a source NL caption [symbol] and edited NL caption [symbol] *. The source NL caption [symbol] can be, for example, user provided or automatically generated using, for instance, a visual language model (VLM) or an off-the-shelf captioning model. For example, given a real image I of a baby wearing a blue shirt and lying on a sofa and a source NL caption [symbol] of “A baby wearing a blue shirt lying on the sofa”, an edited image I* that replaces the baby can be generated based on an edited NL caption [symbol] * that replaces “baby” with “robot” (i.e., “A robot wearing a blue shirt lying on the sofa”).

Such editing operations first require inverting I to the model's output domain. Namely, inverting I so that I can be reconstructed by feeding the inversion, from the inverting, and the source prompt [symbol] to the model, while still retaining the intuitive text-based editing abilities.

Implementations disclosed herein recognize that DDIM inversion produces unsatisfying reconstruction when classifier-free guidance is applied, but provides a good starting point for an optimization, enabling efficient achievement of a high-fidelity inversion. Implementations also recognize that optimizing the unconditional null embedding, which is used in classifier-free guidance, allows an accurate reconstruction while avoiding the tuning of the model and the conditional embedding—thereby preserving the desired editing capabilities.

Text-guided diffusion models aim to map a random noise vector [symbol] ₜ and textual condition [symbol] to an output image [symbol] ₀, where [symbol] corresponds to the given conditioning prompt. In order to perform sequential denoising, the network ϵ₀ is trained to predict artificial noise, following the objective:

$${min}_{θ} {E}_{{z}_{0} , ε \sim N ( 0 , I ) , t \sim Uniform ( 1 , T ) {‖ ∈ - {∈}_{θ} ( {z}_{t} , t , C ) ‖}_{2}^{2} .} \qquad ( 1 )$$

Note that C=ψ( [symbol] ) is the embedding of the text condition and [symbol] ₜ is a noised sample, where noise is added to the sampled data z₀ according to timestamp t. At inference, given a noise vector [symbol] _{T}, the noise is gradually removed by sequentially predicting it using the trained network for T steps.

Since the aim is to accurately reconstruct a given real image, deterministic DDIM sampling can be employed:

$${z}_{t - 1} = \sqrt{\frac{{α}_{t - 1}}{{α}_{t}} {z}_{t} + ( \sqrt{\frac{1}{{α}_{t - 1}} - 1 - \sqrt{\frac{1}{{α}_{t}} - 1 ) \cdot {ε}_{θ} ( {z}_{t} , t , C )}}} .$$

Diffusion models often operate in the image pixel space where [symbol] ₀ is a sample of a real image. For example, some diffusion models operate such that the diffusion forward process is applied on a latent image encoding [symbol] ₀=E(x₀), and an image decoder is employed at the end of the diffusion backward process x₀=D( [symbol] ₀).

One of the challenges in text-guided generation is the amplification of the effect induced by the conditioned text. To this end, classifier-free guidance techniques have been proposed, where the prediction is also performed unconditionally, which is then extrapolated with the conditioned prediction. More formally, let Ø=ψ(″″) be the embedding of a null text and let ω be the guidance scale parameter (e.g., 7.5 or other parameter, such as a default parameter), then the classifier-free guidance prediction is defined by: ε_{θ}( [symbol] ₜ, [symbol] )=ω·ε_{θ}( [symbol] ₜ,t,C)+(1−ω)·ε_{θ}( [symbol] ₜ,t,Ø).

With DDIM inversion, there is an assumption that the ODE process can be reversed in the limit of small steps:

$${𝓏}_{t + 1} = \sqrt{\frac{{α}_{t + 1}}{{α}_{t}} {𝓏}_{t} + ( \sqrt{\frac{1}{{α}_{t + 1}} - 1 - \sqrt{\frac{1}{{α}_{t}} - 1 ) \cdot {ε}_{θ} ( {𝓏}_{t} , t , C )}}} .$$

In other words, with DDIM inversion the diffusion process is performed in the reverse direction, that is [symbol] ₀→ [symbol] _{T} instead of [symbol] _{T}→ [symbol] ₀, where [symbol] ₀ is set to be the encoding of the given real image.

Recent inversion works use random noise vectors for each iteration of their optimization, aiming at mapping every noise vector to a single image. Implementations disclosed herein recognize that this is inefficient as inference requires only a single noise vector. Instead, those implementations seek to perform a more local optimization, such as one that uses only a single noise vector. For example, some of those implementations aim to perform an optimization around a pivotal noise vector which is a good approximation and thus allows a more efficient inversion.

With DDIM inversion, a slight error is incorporated in every step. For unconditional diffusion models, the accumulated error is negligible and the DDIM inversion succeeds. However, meaningful editing using some text-guided diffusion models requires applying classifier-free guidance with a large guidance scale (e.g., [symbol] >1). Such a guidance scale amplifies the accumulated error. Therefore, performing the DDIM inversion procedure with classifier-free guidance results not only in visual artifacts, but the obtained noise vector might be out of the Gaussian distribution. The latter decreases the editability. That is, the latter decreases the ability to edit using the particular noise vector.

Using DDIM inversion with guidance scale [symbol] =1 provides a rough approximation of the original image, which is highly editable but far from accurate. More specifically, the reversed DDIM produces a T steps trajectory between the image encoding [symbol] ₀ to a Gaussian noise vector

$${𝓏}_{T}^{*} .$$

Again, a large guidance stare is essential for editing. Hence, implementations focus on providing

$${𝓏}_{T}^{*}$$

to the diffusion process with classifier-free guidance (e.g., [symbol] >1). This results in high editability but inaccurate reconstruction, since the intermediate latent codes deviate from the trajectory.

Motivated by the high editability, this initial DDIM inversion with [symbol] =1 is referred to herein as a pivot trajectory and optimization is performed around the pivot trajectory with the guidance scale, [symbol] >1. That is, the optimization maximizes the similarity to the original image, while maintaining the ability to perform meaningful editing. A separate optimization can be performed for each timestamp t in the order of the diffusion process t=T→t=1, with the objective of getting as close as possible to the initial trajectory:

$${𝓏}_{T}^{*} , … , {𝓏}_{0}^{*} : min {‖ {𝓏}_{t - 1}^{*} - {𝓏}_{t - 1} ‖}_{2}^{2} , \qquad ( 2 )$$

In the preceding, [symbol] ₜ₋₁ is the intermediate result of the optimization. Since pivotal DDIM inversion provides a good starting point, this optimization is highly efficient compared to using random noise vectors. Note that for every t<T, the optimization should start from the endpoint of the previous step (t+1) optimization, otherwise the optimized trajectory would not hold at inference. Accordingly, after the optimization of step t, the current noisy latent code [symbol] can be computed, which is then used in the optimization of the next step to ensure the new trajectory would end near [symbol] ₀ (see e.g., Eq. (3) for more details).

To successfully invert real images into a domain of a text-guided diffusion model, some works optimize the textual encoding, the model's weights, or both. Fine-tuning the model's weight for each image involves duplicating the entire model, which is highly inefficient in terms of memory consumption. Moreover, unless fine-tuning is applied for each and every edit, it necessarily hurts the learned prior of the model and therefore the semantics of the edits. Direct optimization of the textual embedding results in a non-interpretable representation since the optimized tokens do not necessarily match pre-existing words. Therefore, an intuitive prompt-to-prompt edit becomes more challenging with such works.

Instead, implementations disclosed herein exploit a feature of classifier-free guidance. That is, that the result is highly affected by the unconditional prediction. Those implementations replace the default null-text embedding with an optimized one, referred to herein as null-text optimization. Namely, for each input image, only the unconditional embedding Ø is optimized, where the unconditional embedding Ø can be initialized with the null-text embedding. The model and the conditional textual embedding are kept unchanged.

This results in high-quality reconstruction while still allowing intuitive editing (e.g., prompt-to-prompt editing) by simply using the optimized unconditional embedding. Moreover, after a single inversion process, the same unconditional embedding can be used for multiple editing operations over the input image. This is computationally efficient as only a single inversion is needed for multiple editing operations. Since null-text optimization is naturally less expressive than fine-tuning the entire model, it requires the more efficient pivotal inversion scheme.

Implementations disclosed herein refer to optimizing a single unconditional embedding Ø as a global null-text optimization. However, some implementations recognize that optimizing a different “null embedding” Øₜ for each timestamp t significantly improves the reconstruction quality, which is well suited for pivotal inversion disclosed herein. Accordingly, those implementations use per-timestamp unconditional embeddings

$${\{ {∅}_{t} \}}_{t = 1}^{T} ,$$

and initialize Øₜ with the embedding of the previous step Øₜ₊₁. Algorithm 1 is presented below and provides an example of some of those implementations.

Algorithm 1: Null-text inversion

```
1 Input: A source prompt embedding C = ψ( [symbol] ) and
Input image I;
2 Output: Noise vector z_{T} and optimized
  $embeddings {\{ {∅}_{L} \}}_{t = 1}^{T} .$
3 Set guidance scale [symbol]  = 1;
$4 Compute the intermediate results {𝓏}_{T}^{*} , … , {𝓏}_{0}^{*} using$
  DDIM inversion over I;
5 Set guidance scale [symbol]  = 7.5;
$6 Initialize {𝓏}_{T}^{-} ← {𝓏}_{T}^{*} , {∅}_{T} ← ψ ( ) ;$
7 for t = T,T − 1, ... , 1 do
8 | for j = 0, ... , N − 1 do
$9 \vert \vert {ϕ}_{t} ← {ϕ}_{t} - η {∇}_{∅} {‖ {𝓏}_{t - 1}^{*} - {𝓏}_{t - 1} ( {\overline{𝓏}}_{t} , {∅}_{t} , C ) ‖}_{2}^{2} ;$
10 | end
11 | Set z̅ₜ̅₋̅₁̅← zₜ₋₁ (z̅ₜ, Øₜ, C), Øₜ₋₁ ← Øₜ;
12 end
$13 Return \overline{{𝓏}_{T}} , {\{ {∅}_{L} \}}_{t = 1}^{T}$
```

The DDIM inversion, with [symbol] =1, outputs a sequence of noisy latent codes

$${𝓏}_{T}^{*} … , {𝓏}_{0}^{*}$$

where

$${𝓏}_{0}^{*} = {𝓏}_{0} \cdot {𝓏}_{T}^{-} = {𝓏}_{t}$$

can be initialized and the following optimization performed with a guidance scale (e.g., 7.5 or other default guidance scale) for the timestamps t=T, . . . , 1, each for N iterations:

$${min}_{{∅}_{t}} {‖ {𝓏}_{t - 1}^{*} - {𝓏}_{t - 1} ( {𝓏}_{t}^{-} , {∅}_{t} , C ) ‖}_{2}^{2} . \qquad ( 3 )$$

For simplicity, [symbol] ₜ₋₁( [symbol] , Øₜ, C) denotes applying DDIM sampling step using [symbol] , the unconditional embedding Øₜ, and the conditional embedding C. At the end of each step, [symbol] = [symbol] ₜ₋₁( [symbol] , Øₜ, C) is updated. Some implementations implement early stopping, which reduces time and/or processor resource consumption. Finally, the real input image can be edited by using the noise

$$\overline{{𝓏}_{T}} = {𝓏}_{T}^{*}$$

and the optimized unconditional embeddings

$${\{ {∅}_{t} \}}_{t = 1}^{T} .$$

Accordingly, implementations provide an approach to invert real images, with corresponding captions, into the latent space of a text-guided diffusion model while maintaining its powerful editing capabilities. Some of those implementations first use DDIM inversion to compute a sequence of noisy latent codes, which roughly approximate the original image (with the given caption), then use this sequence as a fixed pivot to optimize the input null-text embedding. Such optimization compensates for the inevitable reconstruction error caused by the classifier-free guidance component. Once the image-caption pair is accurately embedded in the output domain of the model, prompt-to-prompt editing can be instantly applied at inference time. Through utilization of pivotal inversion and null-text optimization, implementations bridge the gap between reconstruction and editability of real images. Further, implementations avoid computationally intensive model-tuning.

The algorithm for optimizing only a single null-text embedding Ø for all timestamps is presented below in algorithm 2. In this case, since the optimization of Ø in a single timestamp affects all other timestamps, the order of the iterations is changed relative to Algorithm 1. That is, N iterations are performed and, in each, Ø is optimized for all the diffusion timestamps by iterating over t.

Algorithm 2: Global-null-text inversion

```
1 Input: A source prompt P and input image I.
2 Output: Noise vector z_{T} and an optimized
  embeddings Ø.
3 Set guidance scale = 1;
$4 Compute the intermediate results {z}_{T}^{*} , … , {z}_{0}^{*} of$
  DDIM inversion for image I;
5 Set guidance scale [symbol]  = 7.5;
6 Initialize Ø ← ψ (″″);
7 for j = 0, ... , N − 1 do
$8 \vert Set \overline{{𝓏}_{T}} ← {𝓏}_{T}^{*} ;$
9 | for t = T, T − 1, ... , 1 do
$10 \vert ∅ ← ∅ - η ∇ ∅ {‖ {𝓏}_{t - 1}^{*} - {𝓏}_{t - 1} ( {\overline{𝓏}}_{t} , {∅}_{t} , C ) ‖}_{2}^{2} ;$
Set z̅ₜ̅₋̅₁̅← zₜ₋₁ (z̅ₜ, Ø, C);
11 | end
12 end
13 Return z̅_̅{̅T̅}̅, Ø
```

Diffusion Denoising Probabilistic Models (DDPM) are generative latent variable models that aim to model a distribution p_{θ}(x_{θ}) that approximates the data distribution q(x_{θ}) and that are easy to sample from. DDPMs model a “forward process” in the space of x_{θ} from data to noise. This is called “forward” due to its procedure progressing from x_{θ} to x_{T}. Note that this process is a Markov chain starting from x_{θ}, where noise is gradually added to the data to generate the latent variables x_{1, . . . ,} x_{T}∈X. The sequence of latent variables, therefore, follows

$$q ( {x}_{1} , … , {x}_{t} \vert {x}_{0} ) = {\prod }_{i = 1}^{t} q ( {x}_{t} \vert {x}_{t - 1} ) ,$$

where a step in the forward process is defined as a Gaussian transition q(xₜ|xₜ₋₁):=N(xₜ; \sqrt{1−βₜ}xₜ₋₁, βₜl) parameterized by a schedule β₀, . . . , β_{T}∈(0,1). When T is large enough, the last noise vector x_{T} nearly follows an isotropic Gaussian distribution.

An interesting property of the forward process is that one can express the latent variable x₀ directly as the following linear combination of noise and x₀ without sampling intermediate latent vectors:

$${x}_{t} = \sqrt{{α}_{t}} {x}_{0} + \sqrt{1 - {α}_{t}} {𝓌}_{\sim} N ( 0 , I ) , where {a}_{t} := {\prod }_{i = 1}^{t} ( 1 - {β}_{i} ) . \qquad ( 5 )$$

To sample from the distribution q(x₀), the dual “reverse process” p(xₜ₋₁|xₜ) can be defined from isotropic Gaussian noise XT to data by sampling the posteriors q(xₜ₋₁|xₜ). Since the intractable reverse process q(xₜ₋₁|xₜ) depends on the unknown data distribution q(x₀), it can be approximated with a parameterized Gaussian transition network p_{θ}(xₜ₋₁|xₜ):=N(xₜ₋₁|μ_{θ}(xₜ, Σ_{θ}(xₜ,t). The μ_{θ}(xₜ, t) can be replaced by predicting the noise ϵ_{θ}(xₜ, t) added to x₀ using equation 5.

Bayes' theorem can be used to approximate:

$${μ}_{θ} ( {x}_{t} , t ) = \frac{1}{\sqrt{{α}_{t}}} ( {x}_{t} - \frac{{β}_{t}}{\sqrt{1 - {α}_{t}}} {ε}_{θ} ( {x}_{t} , t ) ) ) . \qquad ( 6 )$$

Once there is a trained ϵ_{θ}(xₜ,t), the following sample method can be used:

$${x}_{t - 1} = {μ}_{θ} ( {x}_{t} , t ) + {σ}_{{t}^{𝓏}} , 𝓏 ∼ N ( 0 , I ) . \qquad ( 7 )$$

The σₜ of each sample stage can be controlled, and in DDIMs the sampling process can be made deterministic using σₜ in all the steps. The reverse process can finally be trained by solving the following optimization problem:

$${min}_{θ} L ( θ ) := {min}_{θ} {E}_{{x}_{0 \sim q ( {x}_{0} ) 𝓌 \sim N ( 0 , I ) , {t}^{{‖ 𝓌 - {ε}_{θ} ( {x}_{t} , t ) ‖}_{{2}^{′}}^{2}}}} ,$$

teaching the parameters θ to fit q(x₀) by maximizing a variational lower bound.

As a working example of various implementations of prompt-to-prompt editing disclosed herein, let I be a source image that is a real image and let P be an NL caption for the real image. Some implementations seek to edit the source image I guided only by an edited NL caption P*, resulting in an edited image I*. For example, consider a source image I that is a picture of a new bicycle and that includes the NL caption P “my new bicycle”, and assume that the user wants to edit the color of the bicycle, its material, or even replace it with a scooter while preserving the appearance and structure of the source image I. An intuitive interface for the user is to directly change the NL caption P by further describing the appearance of the bike (e.g., adding “green” before “bicycle”), or replacing it with another word (e.g., replacing “bicycle” with “scooter”). Various implementations disclosed herein avoid relying on any user-defined mask (e.g., defined through interaction with the source image I) to assist or signify where the edit to the source image I should occur. For example, those various implementations avoid relying on any user-defined mask that defines the “bicycle” in the source image I and that is generated based on user interaction with the source image I.

Rather, implementations disclosed herein can use the inversion of the real image, and the edited NL caption, in generating an edited synthetic image that is visually similar to the real image, but that includes the edit(s) reflected in the edited NL caption. For example, in generating the edited synthetic image implementations can process, using an LLI model, the edited NL caption and the final noise vector, and the optimized sequence of unconditional embeddings from inversion of the real image. During the processing, edited conditional embedding(s), that are conditioned based on the edited NL caption, can be generated.

Some examples of specific editing operations, that can be used to define an edited NL caption, are now provided. Those examples include word swap (also referred to as replacement), adding a new phrase (also referred to as addition), and attention reweighting (also referred to as emphasis adjustment).

With word swap, user interface input is provided that indicates a user has swapped token(s) of the original NL caption with others. For example, “bicycle” can be swapped for “car” when the user interface input indicates an edit of the original NL caption of “a big red bicycle” to an edited NL caption of “a big red car”. Such user interface input can be via touch and/or typed inputs to delete “bicycle” and type “car” and/or via spoken user interface input (e.g., spoken input of “replace bicycle with car”).

With adding a new phrase, user interface input is provided that indicates a user has added new token(s) to the original NL caption. For example, “children drawing of” can be prepended to an original NL caption of “a castle next to a river”, when the user interface input indicates such prepending. For example, the user interface input can include typing “children drawing of” at the beginning of the original NL caption or can be spoken user interface input such as “prepend children drawing of”.

With attention re-weighting, user interface input is provided that indicates a user desire to strengthen or weaken the extent to which token(s) of the original NL caption are affecting the real image. For example, the original NL caption can be “a fluffy red ball”, and the user may want an edited image where the ball is more fluffy or less fluffy than it is in the real image. User interface input that indicates such an increase or decrease in fluffiness can be, for example, interaction with a slider or up and down arrows that are presented in conjunction with “fluffy”, bolding or underlining “fluffy”, and/or spoken input (e.g., “more fluffy”).

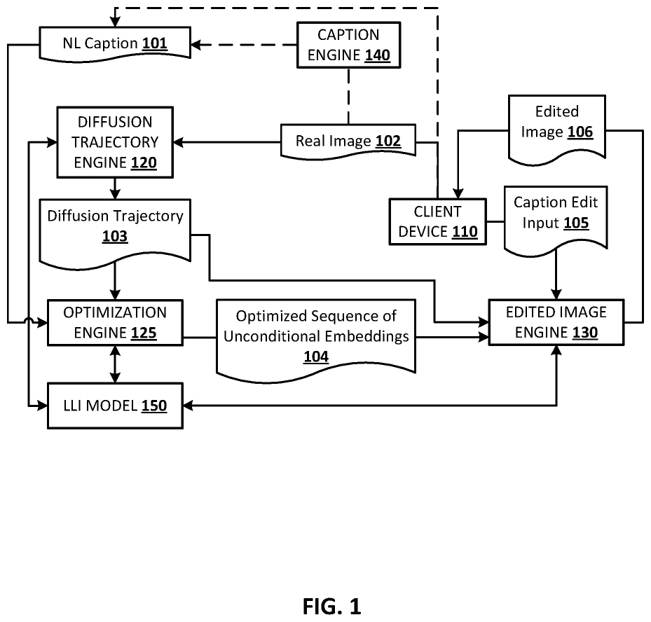

Turning now to the Figures, FIG. 1 schematically depicts example components and interactions that can be utilized in implementations disclosed herein. For example, components and interactions that can be involved in generating, using the LLI model 150, an edited image 106 that is visually similar to a real image 102, but that includes visual modifications consistent with an edit to an NL caption 101 for the real image 102, where the edit is reflected in caption edit input 105.

In FIG. 1, a client device 110 can provide a real image 102 to a diffusion trajectory engine 120. The diffusion trajectory engine 120 can generate a diffusion trajectory 103 for the real image 102. For example, the diffusion trajectory engine 120 can generate the diffusion trajectory 103 using an inversion process and the real image, such as a DDIM inversion process. The diffusion trajectory 103 can include an encoding of the real image 102, a final noise vector, and a sequence of intermediate noise vectors between the encoding and the final noise vector.

The diffusion trajectory 103 is provided to the optimization engine 125, along with an NL caption 101 for the real image 102. The NL caption 101 can be provided by the client device 110 and based on user interface input (e.g., user interface input that is a user-curated caption for the real image 102) and/or can be provided by a caption engine 140 that automatically generates the NL caption 101 by processing the real image 102 using a caption model or other machine learning model(s).

The optimization engine 125 generates an optimized sequence of unconditional embeddings 104. In generating the optimized sequence of unconditional embeddings 104, the optimization engine 125 can generate the optimized sequence of unconditional embeddings 104 based on comparisons of generated predicted latent codes to the diffusion trajectory 103, where each of the generated predicted latent codes is generated during a respective time step of processing, using LLI model 150, that is based on a conditional embedding that is conditioned based on the NL caption 101.

The edited image engine 130 receives caption edit input 105, that is user interface input provided at the client device 110 and that specifies one or more edits to the NL prompt 101 (which can be rendered at the client device 110—optionally based on output from the caption engine 140), such as replacement input, addition input, and/or emphasis adjustment input. In response to receiving the caption edit input 105, the edited image engine 130 can interact with the LLI model 150 in generating an edited image 107 that is visually similar to the real image 102, but that includes visual modifications that are consistent with the edit(s), to the NL caption 101, that are reflected by the caption edit input 105.

In interacting with the LLI model 150 in generating the edited image 106, the edited image engine 130 can utilize the caption edit input 105, at least part of the diffusion trajectory, and the optimized sequence of unconditional embeddings 104.

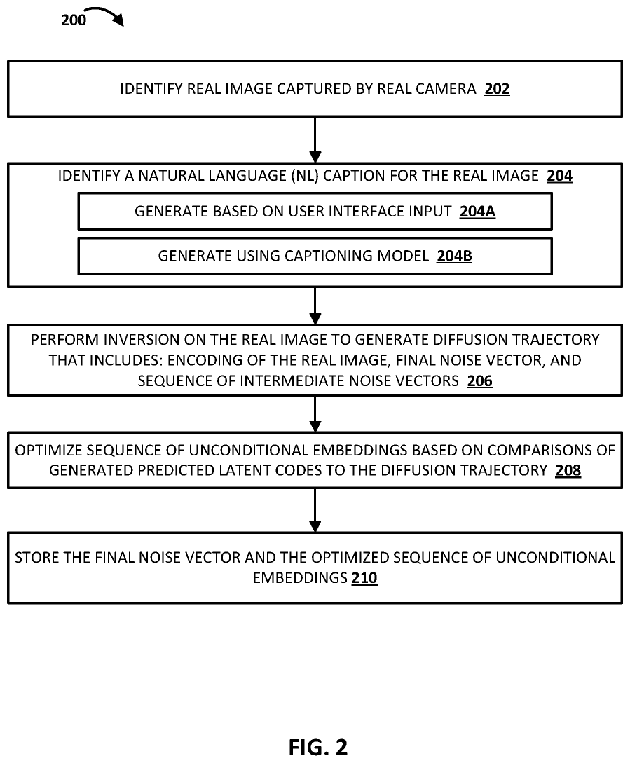

FIG. 2 illustrates an example method 200 of inverting a real image in view of an NL caption for the real image, including generating and storing, for the real image, a final noise vector and an optimized sequence of unconditional embeddings. For convenience, the operations of the flow chart are described with reference to a system that performs the operations. This system can include various components of various computer systems, such as one or more components of server computing device(s). Moreover, while operations of method 200 are shown in a particular order, this is not meant to be limiting. One or more operations can be reordered, omitted or added.

At block 202, the system identifies a real image captured by a real camera, such a real image uploaded from a client device.

At block 204, the system identifies an NL caption for the real image. In identifying the NL caption for the real image, the system can perform sub-block 204A or sub-block 204B.

At sub-block 204A, the NL caption for the real image is generated based on user interface input. For example, when the real image is received from the client device at block 202, the NL prompt can also be received and can be responsive to user interface input received at the client device. For instance, the user interface input can be received, at the client device, responsive to rendering a prompt such as a prompt of “please provide a natural language description of this image”.

At sub-block 204B, the NL prompt for the real image is generated based on processing the real image using a captioning model or other visual language model.

At block 206, the system performs an inversion on the real image to generate a diffusion trajectory. The diffusion trajectory can include an encoding of the real image, a final noise vector, and a sequence of intermediate noise vectors (e.g., between the final noise vector and the encoding). In some implementations, in performing the inversion, the system uses a first guidance scale for classifier-free guidance of the text-guided diffusion model, such as a first guidance scale that causes unconditional embeddings to have a lesser (e.g., no or de minimis) impact in text-guided diffusion. In some implementations, in performing the inversion, the system uses a DDIM inversion process, such as one that includes performing DDIM sampling in reverse order and starting with the encoding of the real image.

At block 208, the system optimizes a sequence of unconditional embeddings based on comparisons of generated predicted latent codes to the diffusion trajectory of block 206. In some implementations, the system generates each of the predicted latent codes during a respective time step of processing, using a text-guided diffusion model, that is based on a conditional embedding that is conditioned based on the NL caption for the real image. In some implementations, in optimizing the sequence of unconditional embeddings the system uses, during processing using the text-guided diffusion model, a second guidance scale for classifier-free guidance of the text-guided diffusion model, such as a second guidance scale that impacts text-guided diffusion (e.g., at least to a greater extent than does a guidance scale utilized in block 206). In some implementations, the comparisons of the generated predicted latent codes to the diffusion trajectory for the image each include a respective mean squared error.

At block 210, the system stores (e.g., at least temporarily in memory), at least the final noise vector and the optimized sequence of unconditional embeddings. The system can store the final noise vector and the optimized sequence of unconditional embeddings in association with the real image of block 202.

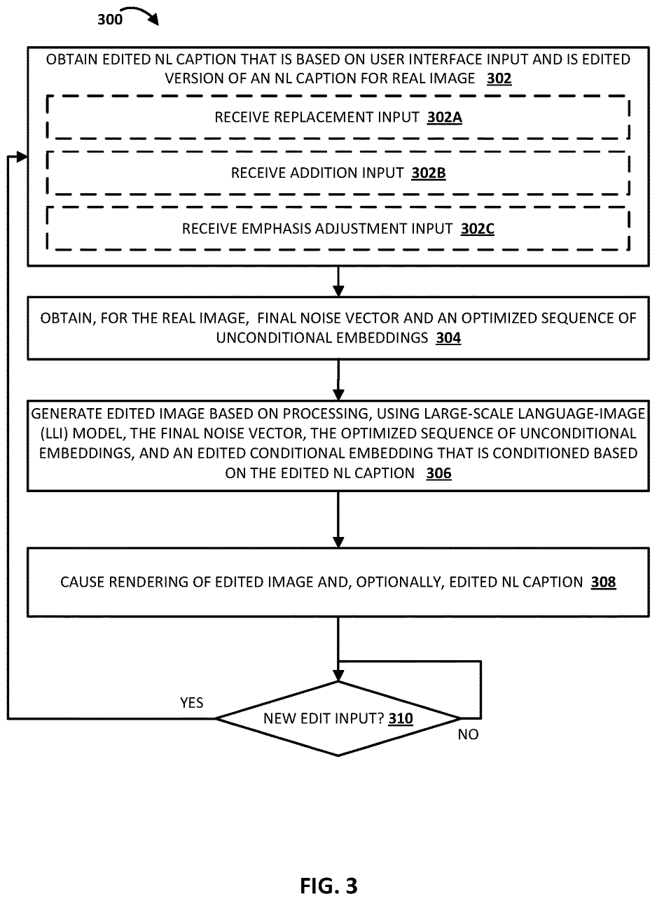

FIG. 3 illustrates an example method 300 of generating, using an LLI model, an edited image that is visually similar to a real image, but that includes visual modifications consistent with an edit to an NL caption for the real image. For convenience, the operations of the flow chart are described with reference to a system that performs the operations. This system can include various components of various computer systems, such as one or more components of server computing device(s). Moreover, while operations of method 300 are shown in a particular order, this is not meant to be limiting. One or more operations can be reordered, omitted or added.

At block 302, the system obtains an edited NL caption that is based on user interface input and that is an edited version of an NL caption for the real image (e.g., an edited version NL caption of block 204 of method 200). The edited NL caption can be generated based on user interface input received, at a client device, responsive to rendering of the real image and/or responsive to rendering the NL caption for the source image. The real image can be the real image of block 202 of an iteration of method 200 of FIG. 2.

In various implementations, block 302 includes one or more of sub-blocks 302A, 302B, and 302C. At sub-block 302A, the user interface of block 302 input includes replacement input. The replacement input can reflect an edit that is a replacement, of a subset of tokens of the NL caption, with one or more replacement tokens that differ from the subset of tokens of the NL caption. At sub-block 302B, the user interface of block 302 input includes addition input. The addition input can reflect an edit that is an addition, of one or more additional tokens, to the NL caption. At sub-block 302A, the user interface of block 302 input includes emphasis adjustment input. The emphasis adjustment input can reflect an edit that is an adjustment of emphasis on one or more emphasis tokens of the NL caption, where the adjustment is an increase or decrease of emphasis and can optionally reflect a magnitude of the increase or decrease.

At block 304 the system obtains, for the real image, at least a final noise vector and an optimized sequence of unconditional embeddings. For example, the system can obtain, for the real image, a final noise vector and an optimized sequence of unconditional embeddings stored, at block 210 of method 200, based on processing the real image and the NL caption (unedited) using method 200.

At block 306, the system generates an edited image based on processing, using an LLI model, the final noise vector, the optimized sequence of unconditional embeddings, and an edited conditional embedding that is conditioned based on the edited NL caption. In some implementations, in generating the edited image, the system uses the edited conditional embedding in each of a plurality of time steps of the processing, and uses a corresponding next one of the unconditional embeddings in each of the plurality of time steps of the processing. In some implementations, in generating the edited image using the LLI model, the system uses the LLI model without tuning any weights of the text-guided diffusion model.

At block 308, the system causes rendering of the edited image and, optionally, of the edited NL caption. For example, the system can cause such rendering at a client device that provided the user interface input of block 302.

At optional block 310, the system can monitor for new user interface input that indicates a further edit to the NL caption, and that is in addition to edit(s) of prior iteration(s) of block 302. If such new user interface input is detected, the system can proceed to perform another iteration of block 302, 304, 306, and 308 based on such new user interface input.

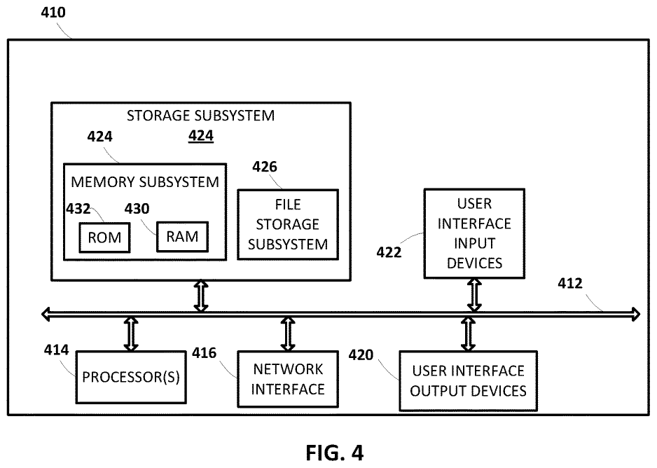

FIG. 4 is a block diagram of an example computing device 410 that can optionally be utilized to perform one or more aspects of techniques described herein. For example, all or aspects of computing device 410 can be incorporated in server(s) or other computing device(s) that are utilized to implement prompt-to-prompt editing techniques disclosed herein.

Computing device 410 typically includes at least one processor 414 which communicates with a number of peripheral devices via bus subsystem 412. These peripheral devices can include a storage subsystem 424, including, for example, a memory subsystem 424 and a file storage subsystem 426, user interface output devices 420, user interface input devices 422, and a network interface subsystem 416. The input and output devices allow user interaction with computing device 410. Network interface subsystem 416 provides an interface to outside networks and is coupled to corresponding interface devices in other computing devices.

User interface input devices 422 can include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 410 or onto a communication network.

User interface output devices 420 can include a display subsystem, a printer, a fax machine, or non-visual displays such as audio output devices. The display subsystem can include a cathode ray tube (CRT), a flat-panel device such as a liquid crystal display (LCD), a projection device, or some other mechanism for creating a visible image. The display subsystem can also provide non-visual display such as via audio output devices. In general, use of the term “output device” is intended to include all possible types of devices and ways to output information from computing device 410 to the user or to another machine or computing device.

Storage subsystem 424 stores programming and data constructs that provide the functionality of some or all of the modules described herein. For example, the storage subsystem 424 can include the logic to perform selected aspects of the methods of FIGS. 2 and/or 3, as well as to implement various components described herein.

These software modules are generally executed by processor 414 alone or in combination with other processors. Memory 424 used in the storage subsystem 424 can include a number of memories including a main random-access memory (RAM) 430 for storage of instructions and data during program execution and a read only memory (ROM) 432 in which fixed instructions are stored. A file storage subsystem 426 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 426 in the storage subsystem 424, or in other machines accessible by the processor(s) 414.

Bus subsystem 412 provides a mechanism for letting the various components and subsystems of computing device 410 communicate with each other as intended. Although bus subsystem 412 is shown schematically as a single bus, alternative implementations of the bus subsystem can use multiple busses.

Computing device 410 can be of varying types including a workstation, server, computing cluster, blade server, server farm, or any other data processing system or computing device. Due to the ever-changing nature of computers and networks, the description of computing device 410 depicted in FIG. 4 is intended only as a specific example for purposes of illustrating some implementations. Many other configurations of computing device 410 are possible having more or fewer components than the computing device depicted in FIG. 4.

While several implementations have been described and illustrated herein, a variety of other means and/or structures for performing the function and/or obtaining the results and/or one or more of the advantages described herein can be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations can be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In some implementations, a method implemented by processor(s) is provided and includes identifying a real image captured by a real camera and identifying a natural language (NL) caption for the real image. The method further includes performing an inversion on the real image to generate a diffusion trajectory for the real image. The diffusion trajectory includes an encoding of the real image, a final noise vector, and a sequence of intermediate noise vectors between the encoding and the final noise vector. The method further includes, subsequent to generating the diffusion trajectory for the real image, optimizing a sequence of unconditional embeddings that are not based on the NL caption for the real image. Optimizing the sequence of unconditional embeddings can be based on comparisons of generated predicted latent codes to the diffusion trajectory for the real image. Each of the generated predicted latent codes can be generated during a respective time step of processing, using a text-guided diffusion model, that is based on a conditional embedding that is conditioned based on the NL caption for the real image. The method further includes obtaining an edited NL caption that is an edited version of the NL caption for the real image. The method further includes generating an edited image that is visually similar to the real image but that includes visual modifications consistent with one or more edits that are reflected by the edited NL caption. Generating the edited image can include generating the edited image based on processing, using the text-guided diffusion model: the final noise vector, the optimized sequence of unconditional embeddings, and an edited conditional embedding that is conditioned based on the edited NL caption.

These and other implementations disclosed herein can include one or more of the following features. In some implementations, performing the inversion includes using, during the inversion a first guidance scale, for classifier-free guidance of the text-guided diffusion model- and optimizing the sequence of unconditional embeddings includes using, during processing using the text-guided diffusion model, a second guidance scale for classifier-free guidance of the text-guided diffusion model. In some versions of those implementations, the first guidance scale causes the unconditional embeddings to have a lesser impact, in text-guided diffusion, than does the second guidance scale. For example, the first guidance scale can cause the unconditional embeddings to have no, or de minimis, impact in text-guided diffusion. In some of those versions, generating the edited image includes using the second guidance scale during processing, using the text-guided diffusion model, to generate the edited image.

In some implementations, generating the edited image based on processing, using the text-guided diffusion model: the final noise vector, the optimized sequence of unconditional embeddings, and the edited conditional embedding includes: using the edited conditional embedding in each of a plurality of time steps of the processing; and using a corresponding next one of the unconditional embeddings in each of the plurality of time steps of the processing.

In some implementations, performing the inversion on the real image includes performing the inversion using a deterministic denoising diffusion implicit model (DDIM) inversion process. In some of those implementations, performing the inversion using the DDIM inversion process includes performing DDIM sampling in reverse order and starting with the encoding of the real image.

In some implementations, the comparisons of the generated predicted latent codes to the diffusion trajectory for the image each include a respective mean squared error.

In some implementations, the NL caption for the real image is automatically generated based on processing the real image using an additional model trained to predict captions for images.

In some implementations, generating the edited image using the text-guided diffusion model includes using the text-guided diffusion model without tuning any weights of the text-guided diffusion model.

In some implementations, the edit includes a replacement, of a subset of tokens of the source NL prompt, with one or more replacement tokens that differ from the subset of tokens of the source NL prompt.

In some implementations, the one or more edits include an addition, of one or more additional tokens, to the NL prompt.

In some implementations, the one or more edits include an adjustment of emphasis on one or more emphasis tokens of tokens of the NL prompt, the adjustment of emphasis being an increase or decrease of emphasis.

In some implementations, obtaining the edited NL caption includes obtaining the edited NL caption based on user interface input that edits a display of the NL caption for the real image. In some versions of those implementations, the user interface input includes typed input and/or an interaction with a graphical user interface that renders the display of the NL caption. In some of those versions, the edit includes an adjustment of emphasis on one or more emphasis tokens of tokens of the NL caption, the adjustment of emphasis being an increase or decrease of emphasis- and the user interface input includes the interaction with the graphical user interface and the interaction includes interaction with a slider that corresponds to the one or more emphasis tokens.

In some implementations, the user interface input includes spoken input that is captured in audio data and the method further includes processing the audio data, using an automatic speech recognition model, to generate recognized text that corresponds to the spoken input, and processing the recognized text to determine the edited NL caption.

In some implementations, a method implemented by processor(s) is provided and includes identifying a real image captured by a real camera and identifying a natural language (NL) caption for the real image. The method further includes performing, using a first guidance scale, a deterministic denoising diffusion implicit model (DDIM) inversion on the real image to generate a diffusion trajectory for the image. The method further includes, subsequent to generating the diffusion trajectory for the image, optimizing a sequence of unconditional embeddings, that are not based on the NL caption for the real image. Optimizing the sequence of unconditional embeddings can be based on using the diffusion trajectory for the image as a pivot during the optimizing and can be based on predicted latent codes generated during processing, using a text-guided diffusion model and a second guidance scale, that is based on a conditional embedding that is conditioned based on the NL caption for the real image. The method further includes using the optimized sequence of unconditional embeddings, and a noise vector from the diffusion trajectory, in generating an edited image that is based on an edited NL caption that is an edited version of the NL caption for the real image. The edited image is visually similar to the real image but includes visual modifications consistent with one or more edits that are reflected by the edited NL caption.

These and other implementations of the technology disclosed herein can include one or more of the following features.

In some implementations, the first guidance scale causes the unconditional embeddings to have a lesser impact, in text-guided diffusion, than does the second guidance scale. For example, the first guidance scale can cause the unconditional embeddings to have no impact in text-guided diffusion.

Other implementations can include a non-transitory computer readable storage medium storing instructions executable by one or more processor(s) (e.g., a central processing unit(s) (CPU(s)), graphics processing unit(s) (GPU(s)), and/or tensor processing unit(s) (TPU(s))) to perform a method such as one or more of the methods described herein. Yet other implementations can include a system of one or more computers that include one or more processors operable to execute stored instructions to perform a method such as one or more of the methods described herein.

1. A method implemented by one or more processors, the method comprising:
identifying a real image captured by a real camera;
identifying a natural language (NL) caption for the real image;
performing an inversion on the real image to generate a diffusion trajectory for the real image, the diffusion trajectory including an encoding of the real image, a final noise vector, and a sequence of intermediate noise vectors between the encoding and the final noise vector;
subsequent to generating the diffusion trajectory for the real image:
optimizing a sequence of unconditional embeddings that are not based on the NL caption for the real image, wherein optimizing the sequence of unconditional embeddings is based on comparisons of generated predicted latent codes to the diffusion trajectory for the real image, each of the generated predicted latent codes being generated during a respective time step of processing, using a text-guided diffusion model, that is based on a conditional embedding that is conditioned based on the NL caption for the real image;
obtaining an edited NL caption that is an edited version of the NL caption for the real image;
generating an edited image that is visually similar to the real image but that includes visual modifications consistent with one or more edits that are reflected by the edited NL caption, wherein generating the edited image comprises generating the edited image based on processing, using the text-guided diffusion model:
the final noise vector,
the optimized sequence of unconditional embeddings, and
an edited conditional embedding that is conditioned based on the edited NL caption.

2. The method of claim 1,
wherein performing the inversion comprises using, during the inversion a first guidance scale, for classifier-free guidance of the text-guided diffusion model; and
wherein optimizing the sequence of unconditional embeddings comprises using, during processing using the text-guided diffusion model, a second guidance scale for classifier-free guidance of the text-guided diffusion model; and
wherein the first guidance scale causes the unconditional embeddings to have a lesser impact, in text-guided diffusion, than does the second guidance scale.

3. The method of claim 2, wherein the first guidance scale causes the unconditional embeddings to have no impact in text-guided diffusion.

4. The method of claim 2, wherein generating the edited image comprises using the second guidance scale during processing, using the text-guided diffusion model, to generate the edited image.

5. The method of claim 1, wherein generating the edited image based on processing, using the text-guided diffusion model: the final noise vector, the optimized sequence of unconditional embeddings, and the edited conditional embedding comprises:
using the edited conditional embedding in each of a plurality of time steps of the processing; and
using a corresponding next one of the unconditional embeddings in each of the plurality of time steps of the processing.

6. The method of claim 1, wherein performing the inversion on the real image comprises performing the inversion using a deterministic denoising diffusion implicit model (DDIM) inversion process.

7. The method of claim 6, wherein performing the inversion using the DDIM inversion process comprises performing DDIM sampling in reverse order and starting with the encoding of the real image.

8. The method of claim 1, wherein the comparisons of the generated predicted latent codes to the diffusion trajectory for the image each comprise a respective mean squared error.

9. The method of claim 1, wherein the NL caption for the real image is automatically generated based on processing the real image using an additional model trained to predict captions for images.

10. The method of claim 1, wherein generating the edited image using the text-guided diffusion model comprises using the text-guided diffusion model without tuning any weights of the text-guided diffusion model.

11. The method of claim 1, wherein the edit comprises a replacement, of a subset of tokens of the source NL prompt, with one or more replacement tokens that differ from the subset of tokens of the source NL prompt.

12. The method of claim 1, wherein the one or more edits comprise an addition, of one or more additional tokens, to the NL prompt.

13. The method of claim 1, wherein the one or more edits comprise an adjustment of emphasis on one or more emphasis tokens of tokens of the NL prompt, the adjustment of emphasis being an increase or decrease of emphasis.

14. The method of claim 1, wherein obtaining the edited NL caption comprises obtaining the edited NL caption based on user interface input that edits a display of the NL caption for the real image.

15. The method of claim 14, wherein the user interface input comprises typed input and/or an interaction with a graphical user interface that renders the display of the NL caption.

16. The method of claim 15,
wherein the edit comprises an adjustment of emphasis on one or more emphasis tokens of tokens of the NL caption, the adjustment of emphasis being an increase or decrease of emphasis; and
wherein the user interface input comprises the interaction with the graphical user interface and wherein the interaction comprises interaction with a slider that corresponds to the one or more emphasis tokens.

17. The method of claim 1, wherein the user interface input comprises spoken input that is captured in audio data and further comprising:
processing the audio data, using an automatic speech recognition model, to generate recognized text that corresponds to the spoken input; and
processing the recognized text to determine the edited NL caption.

18. A method implemented by one or more processors, the method comprising:
identifying a real image captured by a real camera;
identifying a natural language (NL) caption for the real image;
performing, using a first guidance scale, a deterministic denoising diffusion implicit model (DDIM) inversion on the real image to generate a diffusion trajectory for the image;
subsequent to generating the diffusion trajectory for the image:
optimizing a sequence of unconditional embeddings, that are not based on the NL caption for the real image, wherein optimizing the sequence of unconditional embeddings is based on using the diffusion trajectory for the image as a pivot during the optimizing and is based on predicted latent codes generated during processing, using a text-guided diffusion model and a second guidance scale, that is based on a conditional embedding that is conditioned based on the NL caption for the real image; and
using the optimized sequence of unconditional embeddings, and a noise vector from the diffusion trajectory, in generating an edited image that is based on an edited NL caption that is an edited version of the NL caption for the real image,
wherein the edited image is visually similar to the real image but includes visual modifications consistent with one or more edits that are reflected by the edited NL caption.

19. The method of claim 18, wherein the first guidance scale causes the unconditional embeddings to have a lesser impact, in text-guided diffusion, than does the second guidance scale.

20. The method of claim 19, wherein the first guidance scale causes the unconditional embeddings to have no impact in text-guided diffusion.

21. A system comprising memory storing instructions and one or more processors operable to execute the instructions to:
identify a real image captured by a real camera;
identify a natural language (NL) caption for the real image;
perform an inversion on the real image to generate a diffusion trajectory for the real image, the diffusion trajectory including an encoding of the real image, a final noise vector, and a sequence of intermediate noise vectors between the encoding and the final noise vector;
subsequent to generating the diffusion trajectory for the real image:
optimize a sequence of unconditional embeddings that are not based on the NL caption for the real image, wherein optimizing the sequence of unconditional embeddings is based on comparisons of generated predicted latent codes to the diffusion trajectory for the real image, each of the generated predicted latent codes being generated during a respective time step of processing, using a text-guided diffusion model, that is based on a conditional embedding that is conditioned based on the NL caption for the real image;
obtain an edited NL caption that is an edited version of the NL caption for the real image;
generate an edited image that is visually similar to the real image but that includes visual modifications consistent with one or more edits that are reflected by the edited NL caption, wherein generating the edited image comprises generating the edited image based on processing, using the text-guided diffusion model:
the final noise vector,
the optimized sequence of unconditional embeddings, and
an edited conditional embedding that is conditioned based on the edited NL caption.

22. (canceled)
